(19) United States
(12) Patent Application Publication
(10) Pub. No.: US 2025/0093831 A1
(43) Pub. Date: Mar. 20, 2025

(54) Controller and Method

(71) Applicant: SHIMADZU CORPORATION, Kyoto-shi (JP)

(72) Inventors: Seiya KURATA, Kyoto-shi (JP); Masahiro IKEGAMI, Kyoto-shi (JP); Taichi TOMONO, Kyoto-shi (JP)

(21) Appl. No.: 18/697,649

(22) PCT Filed: Sep. 6, 2022
(86) PCT No.: PCT/JP2022/033379

§ 371 Date: Apr. 1, 2024

(30) Foreign Application Priority Data
Oct. 6, 2021 (JP) 2021-164631

(51) Int. Cl. G05B 15/02

(52) U.S. Cl. CPC G05B 15/02

(57) ABSTRACT

A controller comprises: an input unit that receives an input of an experimental protocol designed in a directed graph; a generation unit that generates a dependency list including first dependency information indicating that start of processing of a second node depends on completion of processing of a first node; a selection unit that selects from a plurality of nodes a node at which processing is started based on the dependency list; a command unit that instructs an experimental device to execute the processing of the selected node; and an updating unit that updates the dependency list when any processing of the plurality of nodes is completed, the updating unit updating the first dependency information from first information to second information, the selection unit selecting the second node when the first dependency information is updated from the first information to the second information.

### TECHNICAL FIELD

The present invention relates to a controller and a method, and more particularly, to a controller that controls an experimental device based on an experimental protocol and a method for controlling the experimental device based on the experimental protocol.

### BACKGROUND ART

Conventionally, a configuration in which a user performs an experiment according to an experimental protocol designed on a computer is known. For example, a system disclosed in WO 2016/208623 (PTL 1) acquires and displays a graph in which a chain of experiments is formed in a mesh from a database including information about an experimental protocol.

### CITATION LIST

### Patent Literature

PTL 1: WO 2016/208623

### SUMMARY OF INVENTION

### Technical Problem

When an attempt is made to automate a process based on an experimental protocol, it is conceivable to employ a method in which a controller sequentially executes each processing based on the experimental protocol. According to such a method, the control of the controller can be simplified as the control waits for completion of one processing before proceeding to subsequent processing. For example, the controller only needs to sequentially execute a plurality of pieces of processing included in the experimental protocol as a set of instructions having a one-dimensional array structure.

There is also an experimental protocol concurrently executing a plurality of pieces of processing to conduct an experiment more efficiently. For example, while a sample is prepared with a liquid handler, another sample is separated by a centrifuge or the like and a large number of samples may thus be simultaneously analyzed by multiple devices to produce and analyze more samples.

An experimental protocol including such parallel processing can be created relatively easily by using a directed graph. In a directed graph, processing of an experimental device or the like is represented by a node, and a connection of a plurality of pieces of processing is represented by an edge. An edge is directed from a node to be processed earlier to a node to be processed later. In order to represent parallel processing in a directed graph, for example, a node and a plurality of nodes may be connected by edges.

However, it is not easy to cause a controller to execute an experimental protocol including parallel processing. A controller which repeats such control as waiting for completion of one processing before proceeding to subsequent processing cannot manage an order of a plurality of pieces of processing that are branched from one processing and proceed in parallel.

The present invention has been made in order to solve such a problem, and contemplates increasing efficiency of an experiment based on an experimental protocol created in a directed graph.

### Solution to Problem

According to one aspect of the present invention, a controller controls an experimental device based on an experimental protocol. The controller comprises: an input unit that receives an input of an experimental protocol designed in the form of a directed graph, the graph including a plurality of nodes corresponding to an experiment process; a generation unit that, when the plurality of nodes include a first node and a second node, generates a dependency list including first dependency information, the second node getting executable in response to completion of processing of the first node, the first dependency information indicating that start of processing of the second node depends on the completion of the processing of the first node; a selection unit that selects, based on the dependency list, a node from the plurality of nodes; a command unit that instructs the experimental device to execute the processing of the node selected by the selection unit; and an updating unit that updates the dependency list in response to completion of any processing for one of the plurality of nodes, the selection unit selecting the second node in response to completion of the processing for the first node is completed.

According to another aspect of the present invention, a method is a method for controlling an experimental device based on an experimental protocol. The method comprises the steps of: receiving an input of an experimental protocol designed in the form of a directed graph, the graph including a plurality of nodes corresponding to an experiment process; when the plurality of nodes include a first node and a second node, generating a dependency list including first dependency information, the second node getting executable in response to completion of processing of the first node, the first dependency information indicating that start of processing of the second node depends on the completion of the processing of the first node; selecting, based on the dependency list, a node from the plurality of nodes for starting processing; instructing the experimental device to execute the processing of the node selected by the selection unit; and updating the dependency list in response to completion of any processing for one of the plurality of nodes, the selecting a node at which processing is started including selecting the second node in response to completion of the processing for the first node is completed.

### Advantageous Effects of Invention

According to the present disclosure, efficiency of an experiment based on an experimental protocol created in a directed graph can be increased.

### BRIEF DESCRIPTION OF DRAWINGS

FIG. 1 is a block diagram showing a configuration of an automated experiment management system 1000.

FIG. 2 is a block diagram showing a hardware configuration of a terminal device 400.

FIG. 3 is a diagram showing a GUI configuration of an experimental protocol designing application 500.

FIG. 4 is a diagram illustrating some processing selected in an automated experimental system window.

FIG. 5 is a diagram illustrating a processing node that corresponds to the selected processing added to a protocol design window.

FIG. 6 is a diagram presenting a directed graph DG1 which is an example design of an experimental protocol.

FIG. 7 is a diagram presenting a directed graph DG2 including an operation node of a robotic arm 121.

FIG. 8 is a diagram presenting a directed graph DG3.

FIG. 9 is a diagram representing an event handler created by a controller 110 based on directed graph DG3.

FIG. 10 is a diagram representing an adjacency matrix list created by controller 110 based on directed graph DG3.

FIG. 11 is a diagram representing the event handler updated as processing proceeds based on directed graph DG3.

FIG. 12 is a diagram showing the adjacency matrix list updated as processing proceeds based on directed graph DG3.

FIG. 13 is a flowchart for illustrating a flow of an automated experiment based on an experimental protocol.

FIG. 14 is a flowchart of a process in which controller 110 generates an event handler and an adjacency matrix list according to the experimental protocol.

FIG. 15 is a flowchart of a process in which controller 110 executes the experimental protocol based on the event handler and the adjacency matrix list.

FIG. 16 is a block diagram showing a configuration of automated experiment management system 1000 for illustrating a configuration relevant to a function of controller 110.

FIG. 17 is a block diagram showing a hardware configuration of a server device 200.

FIG. 18 is a block diagram showing a configuration of an automated experiment management system 1100 according to a first exemplary variation.

FIG. 19 is a block diagram showing a hardware configuration of a terminal device 400A according to the first exemplary variation.

FIG. 20 is a block diagram showing a configuration of an automated experimental system 1B according to a second exemplary variation.

FIG. 21 is a block diagram showing a hardware configuration of a controller 110B.

FIG. 22 is a diagram presenting a directed graph DG4.

FIG. 23 is a diagram presenting directed graph DG4 and a directed graph DG5 obtained by adding nodes of robotic arm 121 to directed graph DG4.

### DESCRIPTION OF EMBODIMENTS

An embodiment will now be described in detail with reference to the accompanying drawings. In the following description, identical or corresponding components shown in the figures are identically denoted and in principle will not be described repeatedly.

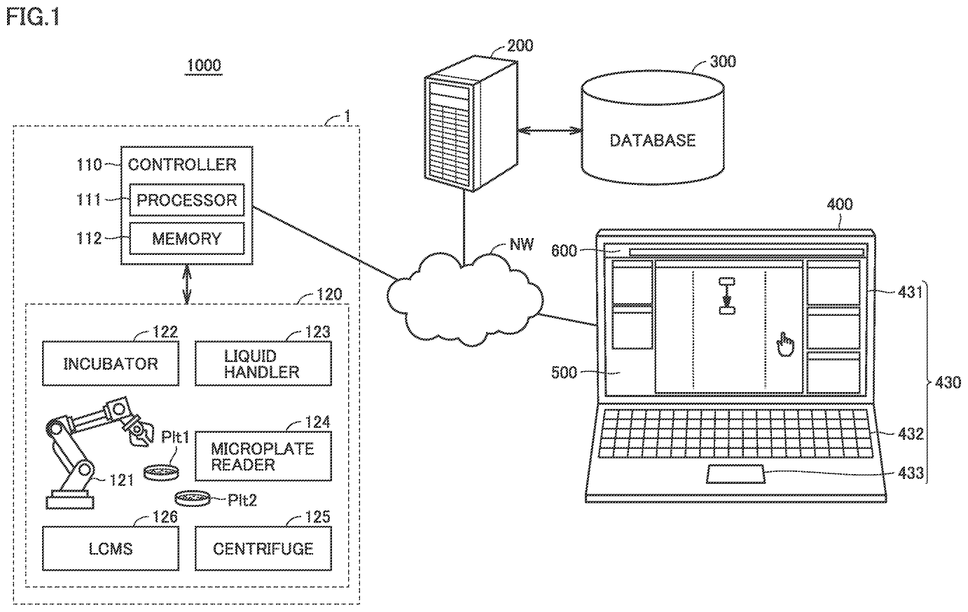

FIG. 1 is a block diagram illustrating a configuration of an automated experiment management system 1000. As illustrated in FIG. 1, automated experiment management system 1000 comprises an automated experimental system 1, a server device 200, a database 300, and a terminal device 400. Database 300 is connected to server device 200. For example, information about automated experimental system 1, information about a sample, an experimental protocol, and output data (an experiment result) by execution of the experimental protocol are registered in database 300.

Terminal device 400 includes an input and output unit 430. Input and output unit 430 includes a display 431, a keyboard 432, and a touch pad 433. For example, terminal device 400 is a notebook computer, a personal computer, a smartphone, and a tablet. Automated experimental system 1, server device 200, and terminal device 400 are interconnected via a network NW. For example, network NW includes the Internet, a wide area network (WAN), or a local area network (LAN). Two or more terminal devices 400 may be connected to network NW and there may be two or more automated experimental systems.

Server device 200 provides an experimental protocol designing application 500 (a specific application) as a web application to terminal device 400. Terminal device 400 displays experimental protocol designing application 500 on display 431 through a Web browser 600. Keyboard 432 and touch pad 433 receive a GUI operation performed by a user to experimental protocol designing application 500. That is, the user of terminal device 400 selects an automated experimental system in experimental protocol designing application 500 by a GUI operation through keyboard 432 and touch pad 433, and designs an experimental protocol to be executed by the automated experimental system.

The experimental protocol defines a processing order of at least one experimental device included in automated experimental system 1 selected by the user. Terminal device 400 sends the experimental protocol designed by the user to server device 200. Server device 200 sends the experimental protocol to automated experimental system 1 designated by the user. By interposing server device 200 between terminal device 400 that designs an experimental protocol and automated experimental system 1 that executes the experimental protocol, a plurality of terminal devices 400 and a plurality of automated experimental systems 1 can collectively be managed by server device 200.

Automated experimental system 1 includes a controller 110 and a plurality of experimental devices 120. Controller 110 controls the plurality of experimental devices 120 to automatically execute the experimental protocol received from server device 200. The plurality of experimental devices 120 include a robotic arm 121, an incubator 122, a liquid handler 123, a microplate reader 124, a centrifuge 125, and a liquid chromatograph mass spectrometer (LCMS) 126. The automated experimental system may include a single experimental device.

Controller 110 includes a processor 111 as a control unit and a memory 112 as a storage unit.

Processor 111 is typically a computing unit such as a central processing unit (CPU) or a multi-processing unit (MPU). Processor 111 reads and executes a program stored in memory 112 to implement a process for executing an experimental protocol.

Memory 112 is implemented by non-volatile memory such as random access memory (RAM), read only memory (ROM), and flash memory. Memory 112 may be composed of CD-ROM (Compact Disc—Read Only Memory), DVD-ROM (Digital Versatile Disk—Read Only Memory), USB (Universal Serial Bus), or the like insofar as it can record a program in a non-transitory manner in a format readable by processor 111.

Robotic arm 121 moves a plate Plt1 or Plt2, which is a container containing a sample, to an experimental device according to an order of a plurality of pieces of processing defined in an experimental protocol. For example, plates Plt1 and Plt2 each contain agar containing a cultured Escherichia coli. Incubator 122 incubates cells while performing temperature control. Liquid handler 123 automatically distributes (dispenses) a fixed amount of sample into each of a plurality of microplates (or wells). Microplate reader 124 for example measures an optical property of the sample in the microplate. Microplate reader 124 measures absorbance and fluorescence intensity. Centrifuge 125 centrifugally separates components of the sample. LCMS 126 separates components of the sample by liquid chromatograph and separates the components for each mass-to-charge ratio (m/z).

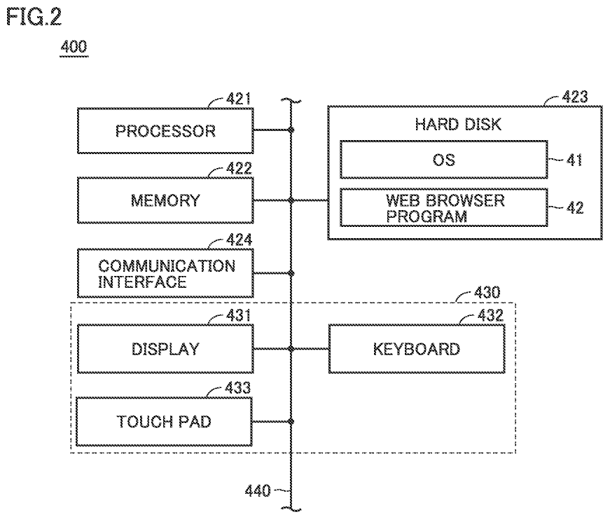

FIG. 2 is a block diagram illustrating a hardware configuration of terminal device 400. As illustrated in FIG. 2, terminal device 400 includes a processor 421, a memory 422 and a hard disk 423 as a storage, a communication interface 424, and input and output unit 430. These are communicably interconnected through a bus 440.

Hard disk 423 is a non-volatile storage device. For example, hard disk 423 stores a program 41 of an operating system (OS) and a Web browser program 42. Other than data in FIG. 2, for example, settings and outputs of a variety of types of applications are stored in hard disk 423. Memory 422 is a volatile storage device and includes a dynamic random access memory (DRAM) for example.

Processor 421 includes a central processing unit (CPU). Processor 421 reads a program stored in hard disk 423 into memory 422 and executes the program. Processor 421 is connected to network NW through communication interface 424.

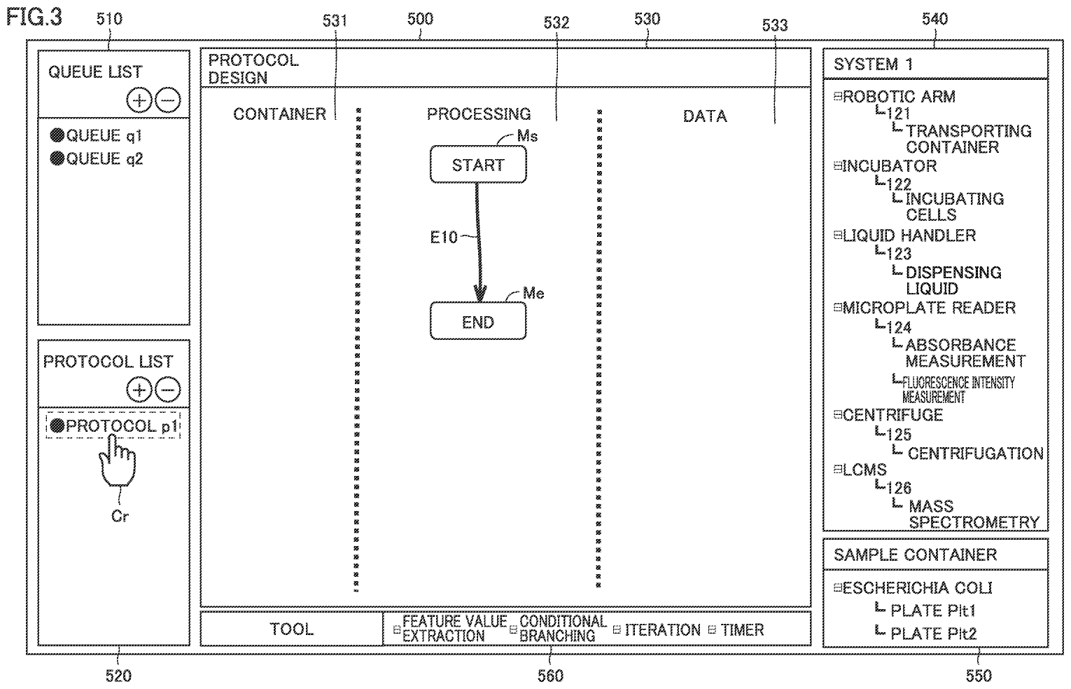

FIG. 3 is a view illustrating a GUI configuration of experimental protocol designing application 500. As illustrated in FIG. 3, experimental protocol designing application 500 includes a queue list window 510, a protocol list window 520, a protocol design window 530, an automated experimental system window 540, a sample container window 550, a tool window 560, and a selection cursor Cr.

Queue list window 510 displays a queue in which a plurality of protocols are ordered. In FIG. 3, queues q1 and q2 are displayed in queue list window 510. Protocol list window 520 displays an experimental protocol. In FIG. 3, an experimental protocol p1 is displayed in protocol list window 520 and selected.

In protocol design window 530, the experimental protocol is designed in a directed graph. In the directed graph, a connection or relationship between a plurality of nodes is defined as an edge. The directed graph is stored as graph structure data according to a predetermined structured data format. For example, the structured data format includes Extensible Markup Language (XML) and JavaScript (registered trademark) Object Notation (Json). A plurality of nodes selectable as vertices of the directed graph are formed as GUIs and include a container node, a processing node, and a data node. A container node is a node corresponding to a container containing a sample. A processing node is a node corresponding to processing of each device included in an automated experimental system. A data node is a node corresponding to output data of processing of an experimental device.

Protocol design window 530 is divided into a container region 531, a processing region 532, and a data region 533. In an initial state in which designing an experimental protocol is started, processing region 532 indicates a start node Ms representing that the experimental protocol starts, an end node Me representing that the experimental protocol ends, and an edge E10 directed from start node Ms to end node Me.

Automated experimental system window 540 indicates processing executable by each of at least one experimental device included in the automated experimental system selected by the user. In FIG. 3, automated experimental system 1 is selected. “Transport of container” is indicated as processing executable by robotic arm 121. “Incubation of cell” is indicated as processing executable by incubator 122. “Dispensing of liquid” is indicated as processing executable by liquid handler 123. “Absorbance measurement” and “fluorescence intensity measurement” are indicated as processing executable by microplate reader 124. “Centrifugation” is indicated as processing executable by centrifuge 125. “Mass spectrometry” is indicated as processing executable by LCMS 126.

Sample container window 550 indicates a container containing a sample. In FIG. 3, plates Plt1 and Plt2 are indicated as a container containing Escherichia coli as an example of the sample.

Tool window 560 indicates specific processing executed by controller 110 of automated experimental system 1. In FIG. 3, “feature value extraction,” “conditional branching,” “iteration,” and “timer” are indicated. “Feature value extraction” corresponds to processing for extracting a feature value designated by a user from data corresponding to a data node selected by the user. “Conditional branching” corresponds to processing for performing branching processing based on whether a condition designated by the user is successful. “Iteration” corresponds to processing for iterating specified processing a number of times designated by the user. “Timer” corresponds to processing for waiting for a period of time designated by the user before an experimental protocol proceeds.

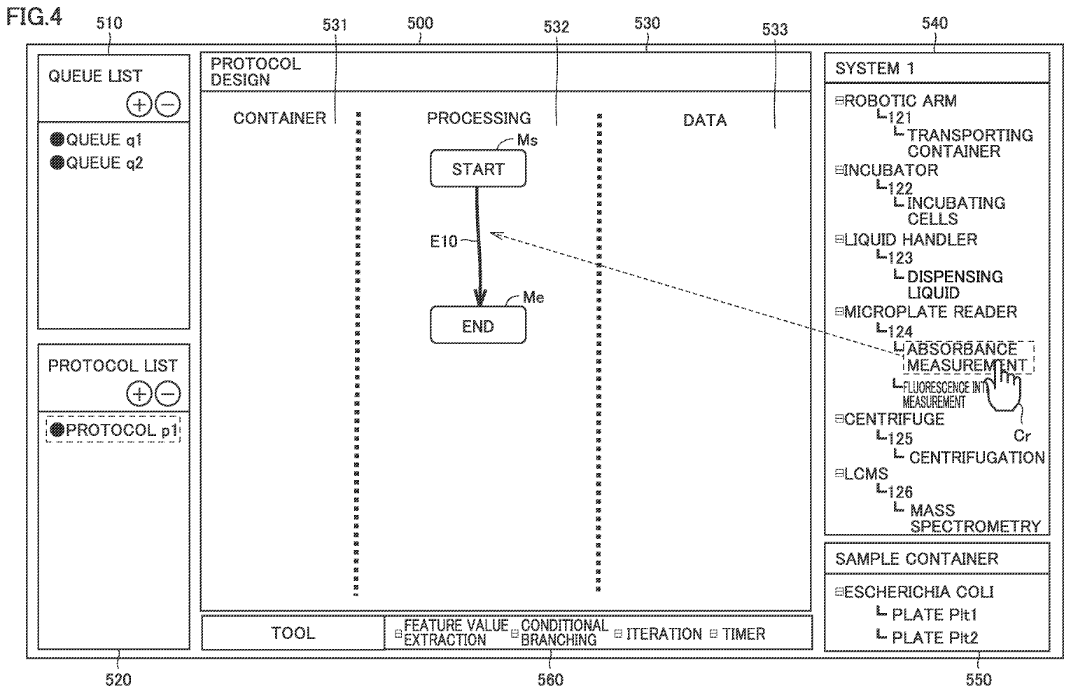

FIG. 4 is a view illustrating some processing selected in automated experimental system window 540. As illustrated in FIG. 4, the user selects “absorbance measurement” in automated experimental system window 540 and drags it between start node Ms and end node Me.

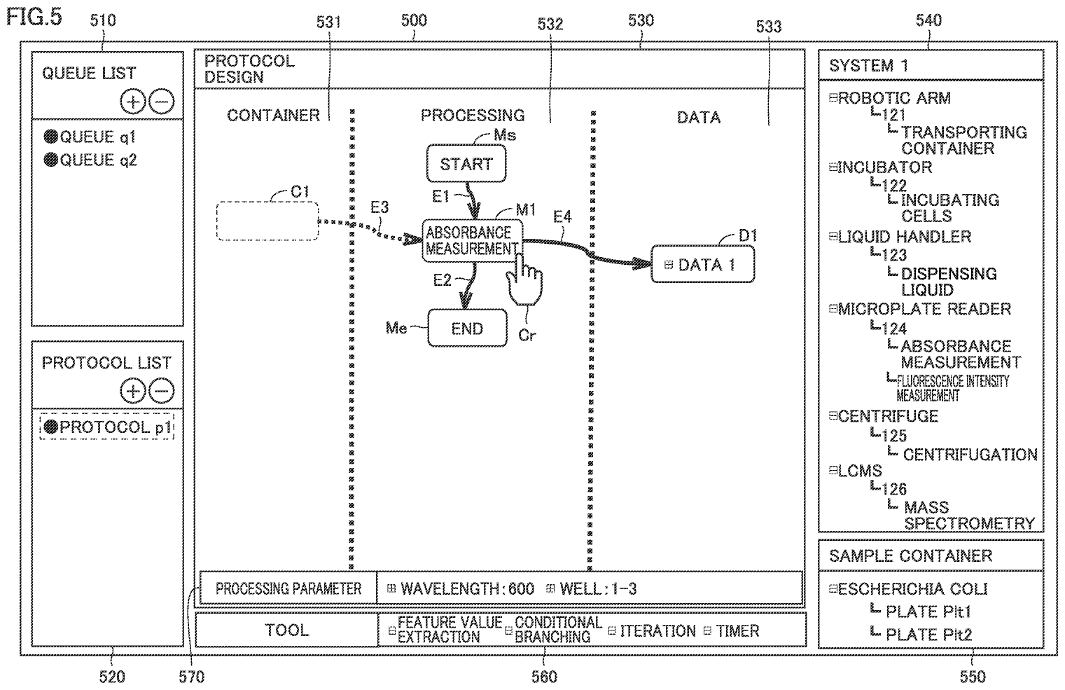

FIG. 5 is a diagram illustrating a state in which a processing node corresponding to selected processing is added to protocol design window 530. As illustrated in FIG. 5, a processing node M1 corresponding to “absorbance measurement” is added between start node Ms and end node Me and selected. As processing node M1 is added, a container node C1 and a data node D1 are automatically added to container region 531 and data region 533, respectively. As processing node M1 is selected, an information window 570 including information about the selected node is indicated. In FIG. 5, a measurement wavelength and a measurement target well are indicated as parameters of absorbance measurement corresponding to processing node M1.

Start node Ms and processing node M1 are connected by an edge E1 directed from start node Ms to processing node M1. Processing node M1 and end node Me are connected by an edge E2 directed from processing node M1 to end node Me. Container node C1 and processing node M1 are connected by an edge E3 (a first edge) directed from container node C1 to processing node M1. Processing node M1 and data node D1 are connected by an edge E4 (second edge) directed from processing node M1 to data node D1. Edge E3 indicates that a container corresponding to container node C1 is input to processing corresponding to processing node M1. Edge E4 indicates that output data of the processing corresponding to processing node M1 corresponds to data node D1. As a processing node is added, container and data nodes connected to the processing node can automatically be added to allow an experimental protocol to be designed efficiently. In FIG. 5, a sample container corresponding to container node C1 is not designated, and accordingly, container node C1 and edge E3 are indicated by dotted lines.

Through the procedure described above, a user can select necessary processing from a window provided by experimental protocol designing application 500 to design an experimental protocol in a directed graph. An example design of an experimental protocol created by a user in the form of a directed graph will now be indicated.

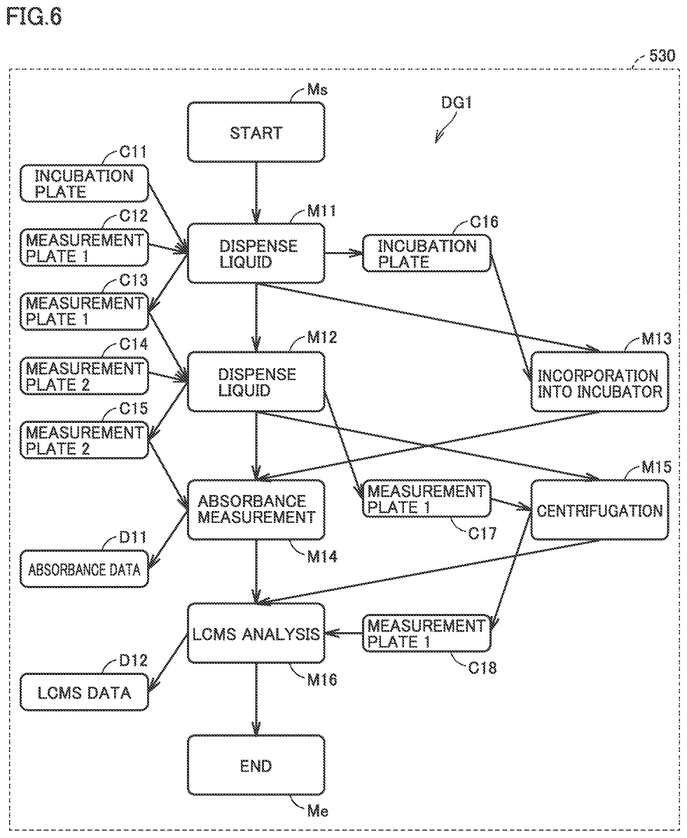

FIG. 6 is a diagram presenting a directed graph DG1 as an example design of an experimental protocol. Protocol design window 530 indicates directed graph DG1. Directed graph DG1 includes start node Ms, end node Me, processing nodes M11, M12, M13, M14, M15 and M16, container nodes C11, C12, C13, C14, C15, C16, C17 and C18, and data nodes D11 and D12.

Processing nodes M11 and M12 correspond to “dispense liquid.” Processing node M13 corresponds to “incorporation into incubator.” Processing node M14 corresponds to “absorbance measurement.” Processing node M15 corresponds to “centrifugation.” Processing node M16 corresponds to “LCMS analysis.”

Container nodes C11 and C16 correspond to “incubation plate.” Container nodes C12, C13, C17, and C18 correspond to a “measurement plate 1.” Container nodes C14 and C15 correspond to a “measurement plate 2.”

Data node D11 corresponds to “absorbance data.” Data node D12 corresponds to “LCMS data.”

Each node is connected to another node by an edge. For example, start node Ms is connected to node M11 by an edge. Nodes C11 and C12 are connected to node M11 by edges. Node M11 is connected to node M12 by an edge. Further, node M11 is connected to node C16 by an edge.

The edges directed from container nodes C11 and C12 to processing node M11 indicate that “dispensing of liquid” corresponding to processing node M11 is performed as an incubation plate and measurement plate 1 are transported to a predetermined position.

The edge directed from processing node M14 to data node D11 indicates that absorbance data is obtained through absorbance measurement.

In this way, in a stage of designing an experimental protocol, a user can use a name of a plate to be transported as a container node, and data obtained according to the experimental protocol as a data node. As a result, the user can intuitively create a directed graph by envisioning how the experimental protocol actually proceeds. The user can create such a directed graph using terminal device 400. Server device 200 stores the directed graph created by terminal device 400. Server device 200 sends the stored directed graph to controller 110 of experimental system 1.

A directed graph including a container node and a data node is advantageous in that when a person sees it the person can intuitively understand how an experimental protocol actually proceeds. This directed graph, however, does not show an operation of robotic arm 121 that transports a plate. In order to automatically execute the experimental protocol based on the directed graph in experimental system 1, the operation of robotic arm 121 needs to be specified as a node. Accordingly, when controller 110 receives the directed graph including container and data nodes, the controller converts the directed graph to a directed graph including an operation node of robotic arm 121.

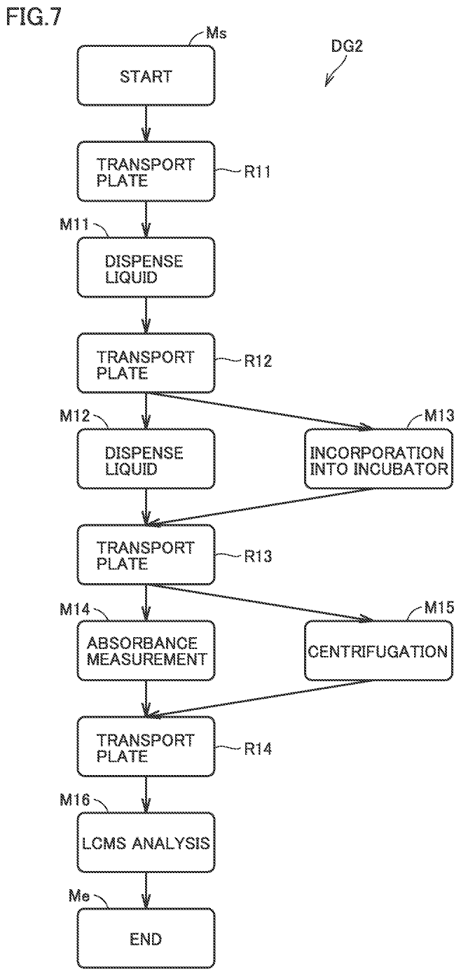

FIG. 7 is a diagram presenting a directed graph DG2 including an operation node of robotic arm 121. Controller 110 converts directed graph DG1 created by a user (see FIG. 6) into directed graph DG2 shown in FIG. 7. Directed graph DG2 includes nodes R11 to R14 corresponding to operation nodes of robotic arm 121. Nodes R11 to R14 are obtained by converting container nodes C11 to C18 shown in FIG. 6 into an operation of robotic arm 121.

For example, node R11 includes processing of node C11 for the incubation plate and processing of node C12 for measurement plate 1. Node R12 includes processing of node C13 for measurement plate 1, processing of node C14 for plate 2, and processing of node C16 for the incubation plate. Node R13 includes processing of node C15 for measurement plate 2 and processing of node C17 for measurement plate 1. Node R14 includes processing of node C18 for measurement plate 1.

In this way, controller 110 converts a directed graph including container and data nodes into a directed graph including an operation node of robotic arm 121. For operation nodes R11 to R14 of directed graph DG2 shown in FIG. 7, for the sake of simplicity, information of a plate transported by robotic arm 121 and a device that is a destination of the transported plate is omitted. An operation node of a directed graph to be actually used includes these pieces of information.

Thus, as has been described above, according to the present embodiment, a user can easily design an experimental protocol in a directed graph. In particular, by creating an experimental protocol in a directed graph, the user can relatively easily design a complicated experimental protocol including parallel processing.

According to controller 110 of the present embodiment, a directed graph including container and data nodes is converted into a directed graph including an operation node of robotic arm 121. Therefore, the user can create a directed graph as illustrated in FIG. 6 while envisioning how an experimental protocol actually proceeds without considering an operation of robotic arm 121.

Further, depending on the directed graph, a plurality of nodes' respective pieces of processing can be caused to concurrently proceed to conduct an experiment more efficiently. For example, directed graph DG2 shown in FIG. 7 defines that after the processing of node R12 is completed, nodes M12 and M13 are executed in parallel, and that after the processing of node M12 and that of M13 are both completed, the processing of node R13 is executed.

However, it is not easy to cause controller 110 to execute an experimental protocol including parallel processing. For example, controller 110 configured to wait for the processing of one node to be completed, and issue an instruction to process a subsequent node, cannot manage a plurality of nodes' respective pieces of processing that proceed in parallel.

Accordingly, a conventional experiment executing software causes devices to operate one by one sequentially to perform an experiment work sequentially. In general, when an automated experimental system composed of a plurality of devices is operated, it is easier to operate the devices one by one sequentially than operate the devices in parallel. This is because each device included in the automated experimental system can be controlled by sequentially executing instructions of a set having a one-dimensional array structure. In this method, however, the experiment executing software will first receive completion of an operation corresponding to an instruction from a device that the experiment executing software provided with that instruction, and will subsequently provide an instruction to another device.

An experimental protocol allows an experiment to be conducted more efficiently by operating a plurality of devices in parallel. For example, while a sample is prepared with liquid handler 123, another sample can be centrifuged by centrifuge 125 or a large number of samples can be analyzed in parallel by a plurality of liquid chromatograph mass spectrometers 126 to prepare and analyze more samples in a short period of time.

In order to automatically execute an experimental protocol created in a directed graph and including parallel processing, an array of instructions having a one-dimensional array structure may include a variety of types of information such as a period of time required for processing of each node. This, however, requires a user to consider information of a node for which it is necessary to wait for its processing to be completed in order to start processing of some node, information about a period of time required for processing of each node, information such as a time when processing of the node is started, etc., and set such information in a system. Such a setting operation is a burden on the user.

Accordingly, in the present embodiment, there is proposed a method in which controller 110 can automatically execute an experimental protocol created in a directed graph without forcing a user to perform such a designing work as described above. Specifically, controller 110 generates an event handler and an adjacency matrix list based on a directed graph. The event handler and the adjacency matrix list are data used by controller 110 to proceed with an experiment based on the directed graph.

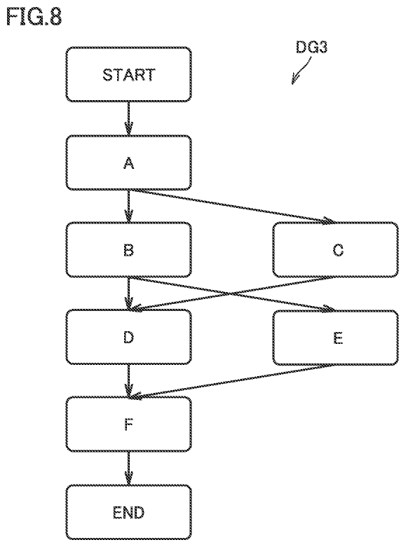

FIG. 8 is a diagram presenting a directed graph DG3. Herein, in order to facilitate understanding of the event handler and the adjacency matrix list, the event handler and the adjacency matrix list will be described using directed graph DG3 with a small number of nodes. As shown in FIG. 8, it is assumed that directed graph DG3 includes nodes A to F in addition to a start node and an end node. Nodes A to F are, for example, a variety of types of processing nodes including an operation node of robotic arm 121 shown in FIG. 7. In FIG. 8, these processing nodes are represented by concepts A to F.

As shown in FIG. 8, according to directed graph DG3, nodes B and C need to be processed in parallel. In order to conduct an experiment more efficiently, the processing of node B and that of node C must be executed quickly after the processing of node A is completed. However, it is not easy for controller 110 to accurately predict when the processing of node A is completed. Controller 110 is required to perform appropriate control while considering that an experiment is conducted efficiently.

According to directed graph DG3, the processing of node D needs to be executed after the processing of node B and that of node C are completed, and the processing of the node F needs to be executed after the processing of node D and that of node E are completed. In order to conduct an experiment more efficiently, the processing of node D needs to be executed quickly once the processing of node B and that of node C have been completed. However, it is not easy for controller 110 to accurately predict when the processing of node B and that of node C are completed. For the same reason, the processing of the node F needs to be executed quickly once the processing of node D and that of node E have been completed. However, it is not easy for controller 110 to accurately predict when the processing of node D and that of E are completed. Controller 110 is required to perform appropriate control while considering that an experiment is conducted efficiently.

According to directed graph DG3, nodes D and E need to be processed in parallel. In order to proceed with the processing of node E, it is necessary to wait for the processing of node B to be completed. In order to proceed with the processing of node D, it is necessary to wait for the processing of node B and that of node C to be completed. In order to efficiently execute parallel processing of nodes D and E, controller 110 is required to perform more complicated control than when implementing parallel processing of nodes B and C.

Controller 110 controls an order of processing of the nodes and when to start the processing of each node by an event handler and an adjacency matrix list. Hereinafter, the event handler and the adjacency matrix list will be described with reference to an example thereof.

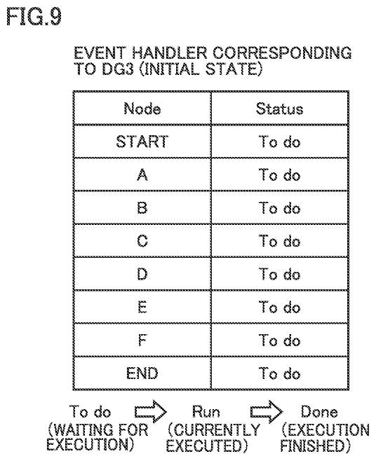

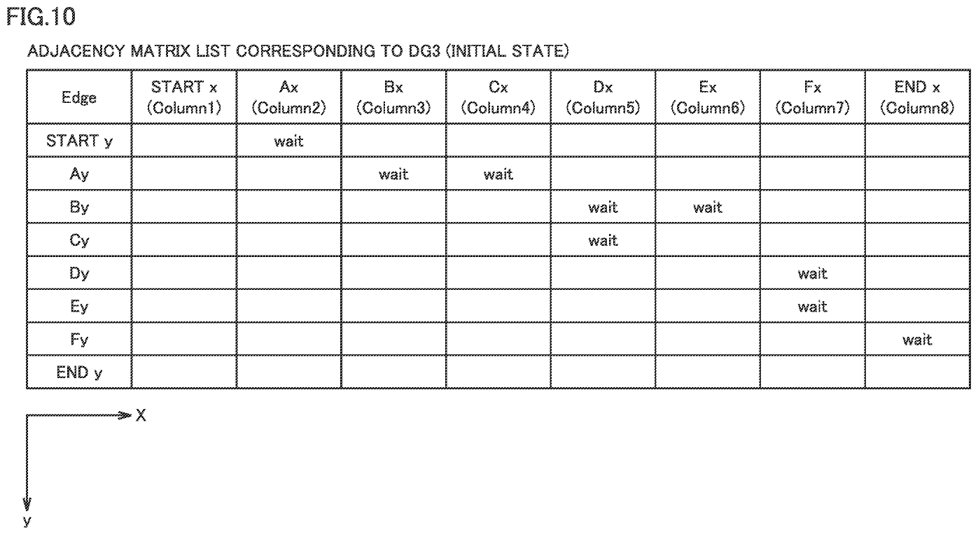

FIG. 9 is a diagram representing an event handler created by controller 110 based on directed graph DG3. FIG. 10 is a diagram of an adjacency matrix list created by controller 110 based on directed graph DG3.

A user designs an experimental protocol, which is sent from server device 200 to controller 110. In order to execute the received experimental protocol, controller 110 generates an adjacency matrix and an event handler based on the experimental protocol. Controller 110 executes the experimental protocol using the event handler and the adjacency matrix list. By utilizing the event handler and the adjacency matrix list, controller 110 can execute an experimental protocol designed in the form of a directed graph.

As shown in FIG. 9, the event handler is composed of a combination of a node of directed graph D3 and a status. The event handler is data indicating a status of processing of a node. Accordingly, the event handler functions as a status list. Herein, “To do” means that a corresponding node's processing waits for execution. In the event handler shown in FIG. 9, all nodes have a status of “To do.” Accordingly, the event handler of FIG. 9 indicates that all nodes' respective pieces of processing are in a state of waiting for execution. The state in which all nodes' respective pieces of processing are in a state of waiting for execution is referred to as an initial state. Controller 110 generates an event handler and an adjacency matrix list corresponding to the initial state based on directed graph D3.

When processing of any node corresponding to “To do” of the event handler is started, the corresponding node's status changes from “To do” to “Run.” When the processing of the node corresponding to “Run” is completed, the status of the processing of that node changes from “Run” to “Done.”

As shown in FIG. 10, the adjacency matrix list is composed of data in a matrix format in which all nodes of directed graph D3 are developed in two directions of an X-axis direction and a Y-axis direction. In FIG. 10, to facilitate understanding, “x” is added to a name of a node aligned in the X-axis direction, and “y” is added to a name of a node aligned in the Y-axis direction. These added symbols need not be provided to actual data.

In the adjacency matrix list, a column start x, a column Ax, a column Bx, a column Cx . . . are configured, and a row start y, a row Ay, a row By, a row Cy . . . are configured. Column start x, column Ax, column Bx, column Cx, . . . are also represented as Column 1, Column 2, Column 3, Column 4, . . . , respectively.

A component value indicating a state of a node is set in the adjacency matrix list. For example, at a position specified in FIG. 10 by column Bx and row Ay, “wait” is set as an example of a component value indicating a state of a node. Hereinafter, the position specified by column Bx and row Ay is represented in a coordinate system using the X-axis and the Y-axis, such as (Bx, Ay).

The adjacency matrix list shown in FIG. 10 is a list corresponding to the initial state. Whether the processing of a node is executable is determined by a component value of the column of its node name. Note that “the processing of a node is executable” means that the processing of another node necessary for executing the processing of the node of interest is completed.

When the processing of a node is completed, controller 110 updates a component value of a row corresponding to its node name from “wait” to “ready.” For example, when the processing of node A is completed, any component value in row Ay is updated from “wait” to “ready.” As a result, (Bx, By) and (Cx, Ay) have their component values updated from “wait” to “ready.”

Thus, updating a component value from “wait” to “ready” is triggered by completion of processing of a node. Further, a target to be updated from “wait” to “ready” is a component value of a row corresponding to a name of a node with its processing completed.

In order to determine whether processing of a node is executable, controller 110 checks a column corresponding to that node. When the column corresponding to the node has at least one component value of “wait,” controller 110 determines that the processing of the node corresponding to the column is not executable. When the column corresponding to the node has no component value of “wait,” controller 110 determines that the processing of the node corresponding to the column is executable. For example, in the state of the adjacency matrix list shown in FIG. 10, the start node is the only node with processing in an executable state. This is because column start x has no component value of “wait,” whereas the other columns have at least one component value of “wait.”

There is no substantial processing in the start node, and accordingly, when the start node's processing is started, it is immediately completed. Controller 110 per se receives a command that it has issued to start the processing of the start node, and the controller generates a completion signal indicating that the processing of the start node is completed. Thus, the processing of the start node is immediately completed. As this is done, controller 110 updates a component value of row start y corresponding to the start node from “wait” to “ready.” As a result, (Ax, start y) has a component value changed to “ready.” Then, column Ax no longer has a component value of “wait.” In the event handler of FIG. 9, node A is in a state of waiting for execution of processing. From the state of the event handler and that of the adjacency matrix list, it is determined that the processing of node A is executable.

Controller 110 starts the processing of node A and also updates in the adjacency matrix list any component value of column Ax from “ready” to “passed.” As a result, (Ax, start y) has its component value changed to “passed.”

Thus, updating a component value from “ready” to “passed” is triggered by completion of processing of a node. Further, a target to be updated from “ready” to “passed” is a component value of a column corresponding to a name of a node with its processing started.

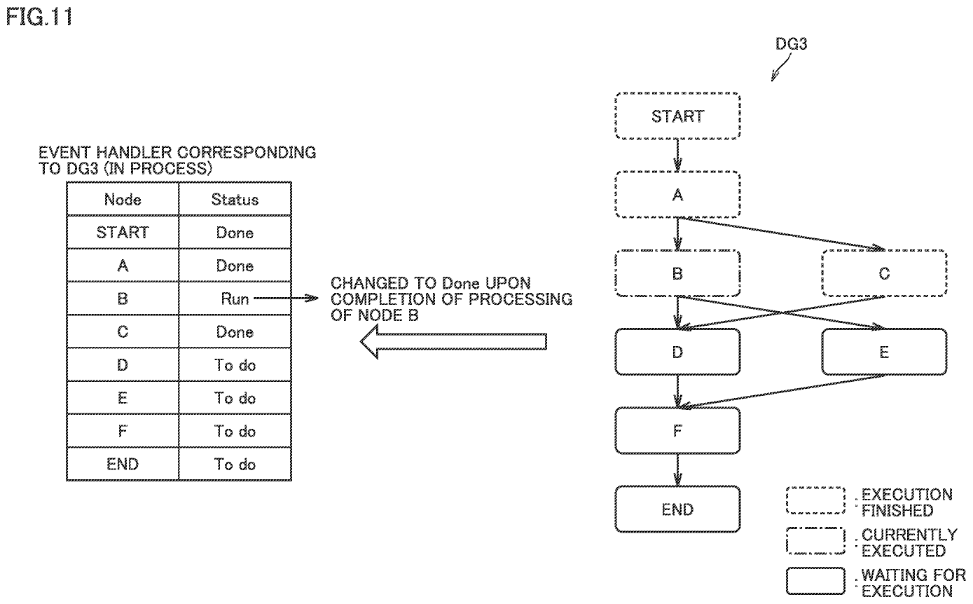

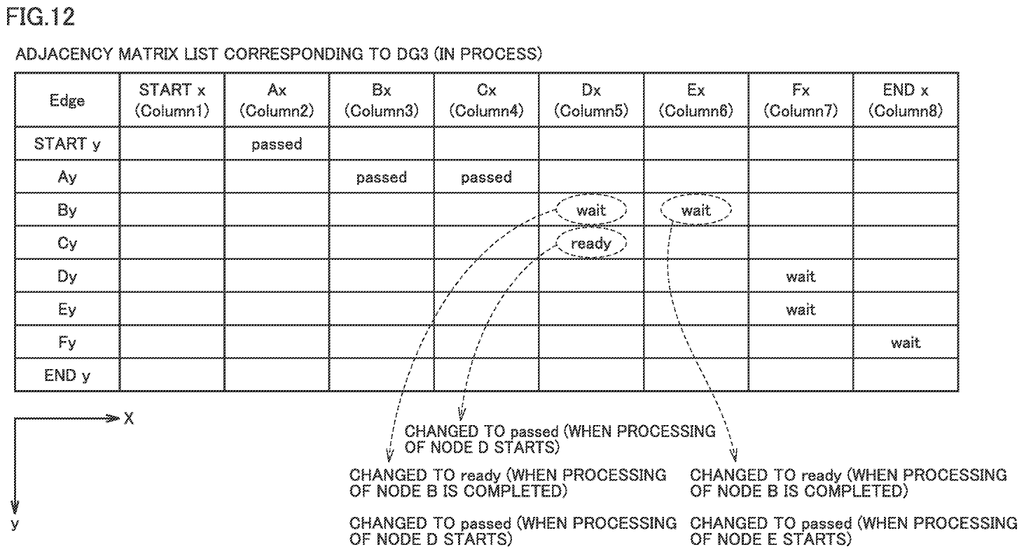

Hereinafter, an example of the event handler and adjacency matrix list when the experiment based on the experimental protocol proceeds will be described. FIG. 11 is a diagram representing the event handler updated as processing proceeds based on directed graph DG3. FIG. 12 is a diagram presenting the adjacency matrix list updated as processing proceeds based on directed graph DG3.

As shown in FIG. 11, herein, a state in which, of directed graph D3, the start node and nodes A and C have their pieces of processing completed and node B has its processing currently executed will be referred to as an example, and the event handler and the adjacency matrix list in that state will be described.

A state of processing of a node in directed graph D3 is reflected in the event handler. As shown in FIG. 11, statuses corresponding to the start node, node A, and node C are “Done,” and a status corresponding to node B is “Run.” Statuses corresponding to node D, node E, node F, and the end node waiting for processing are “To do.”

In the adjacency matrix list shown in FIG. 12, column Ax, column Bx, and column Cx have “passed” as their component values. These component values mean that nodes A, B, and C do not have their pieces of processing waiting for processing. Herein, by referring to the event handler shown in FIG. 11, it is determined that the processing of node A and that of node C have been executed and the processing of node B is currently executed. Controller 110 identifies these states by referring to the event handler and the adjacency matrix list.

In the adjacency matrix list, (Dx, Cy) has a value of “ready,” whereas (Dx, By) has a value of “wait.” The value of (Dx, By) means that the processing of node B corresponding to row By is not completed. The value of (Dx, Cy) means that the processing of node C corresponding to row Cy is completed.

Once the processing of node B has been completed, controller 110 changes a status corresponding to node B of the event handler from “Run” to “Done.” Furthermore, once the processing of node B has been completed, controller 110 changes the “wait” in the adjacency matrix list at two locations in row By to “ready.” As a result, column Dx and column Ex no longer have “wait.” Controller 110 can then determine that nodes D and E are executable. Controller 110 starts the processing of node D and that of node E and also changes the statuses of nodes D and E of the event handler from “To do” to “Run.” Further, controller 110 changes the “ready” of column Dx and column Ex of the adjacency matrix list to “passed.”

As described above, controller 110 generates an adjacency matrix list in which connections between nodes in an experimental protocol are represented by components of a matrix, and changes the values of the components of the adjacency matrix list to manage timing of executing the processing of the nodes. When processing of a node in the adjacency matrix list having dependency is all completed, controller 110 issues a command to process a subsequent node. A single node is basically composed of an instruction having information of a condition for an operation of a single device. When processing corresponding to a node is executed, an instruction corresponding to that node is transmitted from controller 110 to a target device. When controller 110 receives a completion signal indicating completion of an operation from the device that the controller has transmitted the instruction to, the controller determines that the processing corresponding to the node has been completed.

Controller 110 may output the latest event handler and adjacency matrix list to terminal device 400 when conducting an automated experiment. Terminal device 400 may display the received event handler and adjacency matrix list by a display device.

Thus, controller 110 generates an event handler and an adjacency matrix list based on a directed graph. Based on the event handler and the adjacency matrix list, controller 110 executes an experimental protocol designed by the directed graph.

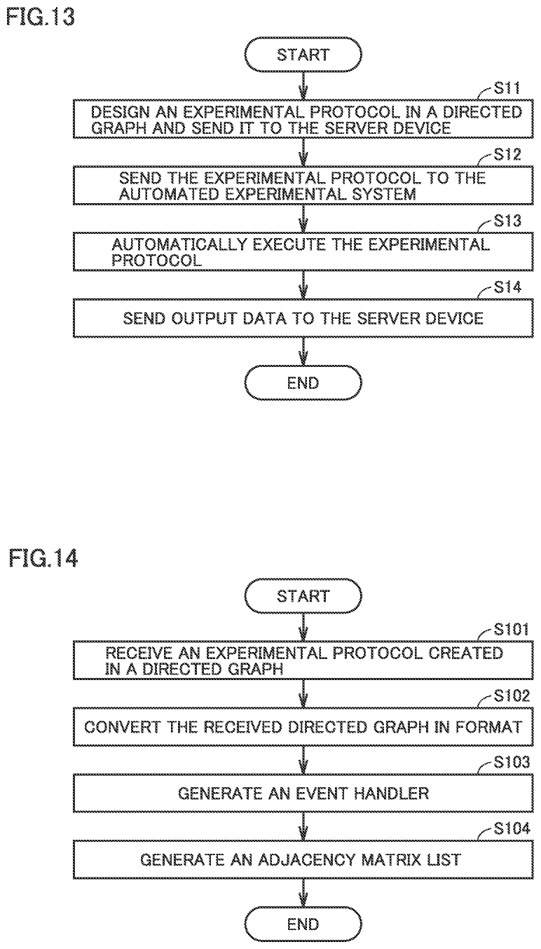

FIG. 13 is a flowchart for illustrating a flow of an automated experiment based on an experimental protocol. As shown in FIG. 13, terminal device 400 designs an experimental protocol in a directed graph based on a user's operation, and sends the experimental protocol to server device 200 (step S11). Server device 200 sends the experimental protocol to automated experimental system 1 in response to the user's operation (step S12). Controller 110 of automated experimental system 1 automatically executes the experimental protocol received from server device 200 (step S13). Controller 110 sends to server device 200 output data of processing included in the experimental protocol (step S14).

In the present embodiment, a case in which an experimental protocol designed in terminal device 400 is sent to automated experimental system 1 via server device 200 has been described. Terminal device 400 may directly send the experimental protocol to automated experimental system 1.

A process in which controller 110 automatically executes an experimental protocol (the FIG. 13 step S13) will now be described more specifically with reference to a flowchart. FIG. 14 is a flowchart of a process in which controller 110 generates an event handler and an adjacency matrix list according to an experimental protocol.

Initially, controller 110 receives an experimental protocol created in a directed graph (step S101). The experimental protocol created in the directed graph is sent from server device 200 to controller 110.

Subsequently, controller 110 converts the received directed graph in format (step S102). Specifically, controller 110 converts the received directed graph in format to include an operation node of robotic arm 121. Thus, for example, the directed graph shown in FIG. 6 is converted into the directed graph shown in FIG. 7.

Subsequently, controller 110 generates an event handler and an adjacency matrix list based on the converted directed graph (steps S103 and S104), and ends a process based on this flowchart. For example, based on the directed graph shown in FIG. 8, controller 110 generates the event handler shown in FIG. 9 and the adjacency matrix list shown in FIG. 10.

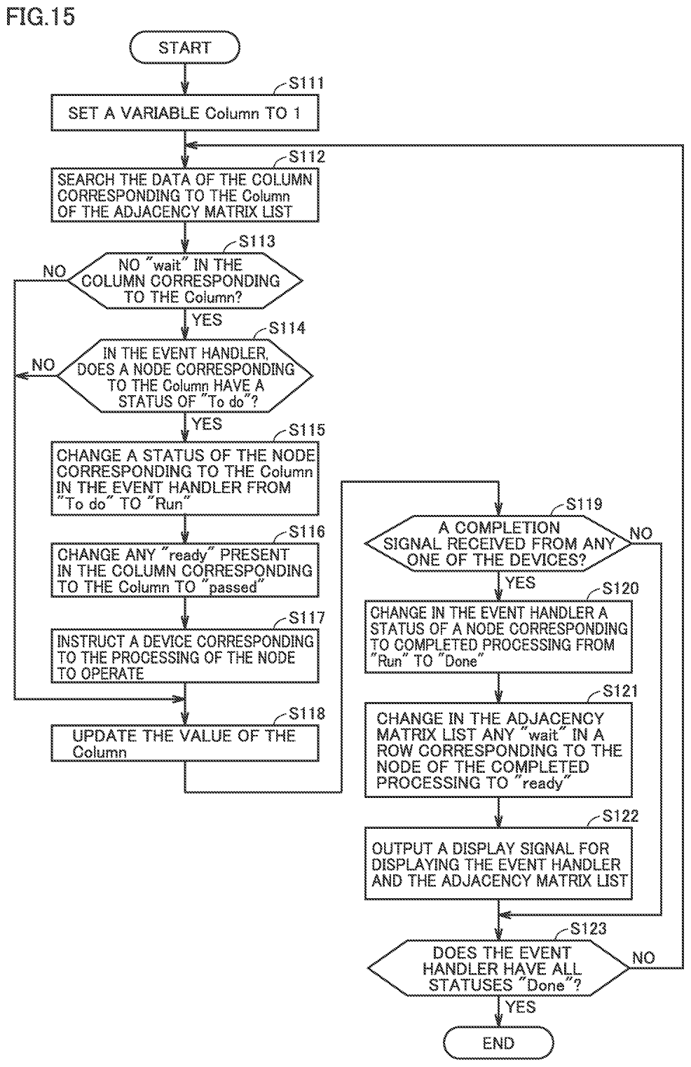

FIG. 15 is a flowchart of a process in which controller 110 executes an experimental protocol based on an event handler and an adjacency matrix list.

Initially, controller 110 sets a variable Column to 1 (step S111). Herein, Column corresponds to the number of a column of the adjacency matrix list shown in FIG. 10. For example, the Column set to 1 in step S111 corresponds to column start x shown in FIG. 10.

Subsequently, controller 110 searches the data of the column corresponding to the Column of the adjacency matrix list (step S112). Subsequently, controller 110 determines whether there is “wait” in the column corresponding to the Column (step S113). When there is no “wait” in the column corresponding to the Column, controller 110 proceeds to step S118 to update the value of the Column. For example, the value of Column is updated from 1 to 2.

When controller 110 determines in step S113 that there is no “wait” in the column corresponding to the Column, the controller determines in the event handler whether a node corresponding to the Column has a status of “To do” (step S114). Controller 110 thus confirms that the node corresponding to the Column is a target to be processed and is waiting for execution.

When controller 110 determines in step S114 that the node corresponding to the Column does not have a status of “To do,” the controller proceeds to step S118. When controller 110 determines in step S114 that the node corresponding to the Column has a status of “To do,” the controller changes a status of the node corresponding to the Column in the event handler from “To do” to “Run” (step S115). Thus, a node at which processing is newly started is selected by controller 110. Subsequently, controller 110 changes any “ready” present in the column corresponding to the Column to “passed” (step S116).

Subsequently, controller 110 instructs a device corresponding to the processing of the node to operate (step S117). By step S117, the processing corresponding to the node having a status changed to “Run” in step S115 is executed.

The device corresponding to the processing of the node includes, for example, robotic arm 121, incubator 122, liquid handler 123, microplate reader 124, centrifuge 125, and liquid chromatograph mass spectrometer 126. These devices receive an instruction from controller 110 in step S117 for an operation corresponding to the processing of the node. These devices perform an operation according to the instruction to implement processing included in the experimental protocol. When these devices complete the operation according to the instruction, the devices transmit to controller 110 a completion signal indicating that the operation is completed.

The device corresponding to the processing of the node further includes a controller 110. In addition to the processing of the start node and that of the end node, controller 110 executes processing of a node corresponding to “feature value extraction” or the like. Controller 110 per se performs an operation in response to its own instruction to implement processing included in the experimental protocol. Once controller 110 has completed the operation in response to the instruction, the controller returns to itself a completion signal indicating that the operation is completed.

Subsequently, controller 110 updates the value of the Column (step S118). Subsequently, controller 110 determines whether a completion signal is received from any one of the devices (step S119). When controller 110 does not receive the completion signal, controller 110 proceeds to step S122. When controller 110 has received the completion signal, controller 110 changes in the event handler a status of a node corresponding to completed processing from “Run” to “Done” (step S120).

Further, controller 110 changes in the adjacency matrix list any “wait” in a row corresponding to the node of the completed processing to “ready” (step S121). For example, when the processing of node B ends, the “wait” at two locations in row By of the FIG. 10 adjacency matrix list is changed to “ready.”

Subsequently, controller 110 outputs a display signal for displaying the event handler and the adjacency matrix list (step S122). The user may previously notify controller 110 of a destination to which the display signal is output. In that case, controller 110 outputs the display signal of the event handler and adjacency matrix list to the destination that the controller is notified of. For example, when a display device is connected to controller 110, controller 110 may output the display signal to the display device. Thus, the display device displays the event handler and the adjacency matrix list.

When a display device is connected to terminal device 400, controller 110 may output the display signal to terminal device 400. In that case, terminal device 400 displays the event handler and the adjacency matrix list on a screen of the display device.

The user can view the event handler and the adjacency matrix list in the latest state on the screen. The user can thus easily grasp how the automated experiment proceeds.

Subsequently, controller 110 determines whether the event handler has all statuses “Done” (step S123). When the event handler does not have all statuses “Done,” there will be processing of a node which is not executed. Accordingly, in that case, controller 110 returns to step S112 and repeats the process. When controller 110 determines that the event handler has all statuses “Done,” controller 110 determines that the experimental protocol's scheduled processing has all been done, and the controller ends the process based on this flowchart.

Controller 110 executes an experimental protocol based on a directed graph in the above-described procedure using an event handler and an adjacency matrix list. Therefore, controller 110 can appropriately control parallel processing of a plurality of nodes such as included in directed graph DG3 (see FIG. 8). Further, controller 110 can also appropriately control the processing of a node, such as nodes D and F included in directed graph DG3, that needs to be started after waiting for a plurality of nodes' respective pieces of processing to be completed. As a result, controller 110 can increase in efficiency an experiment based on the experimental protocol created in the directed graph.

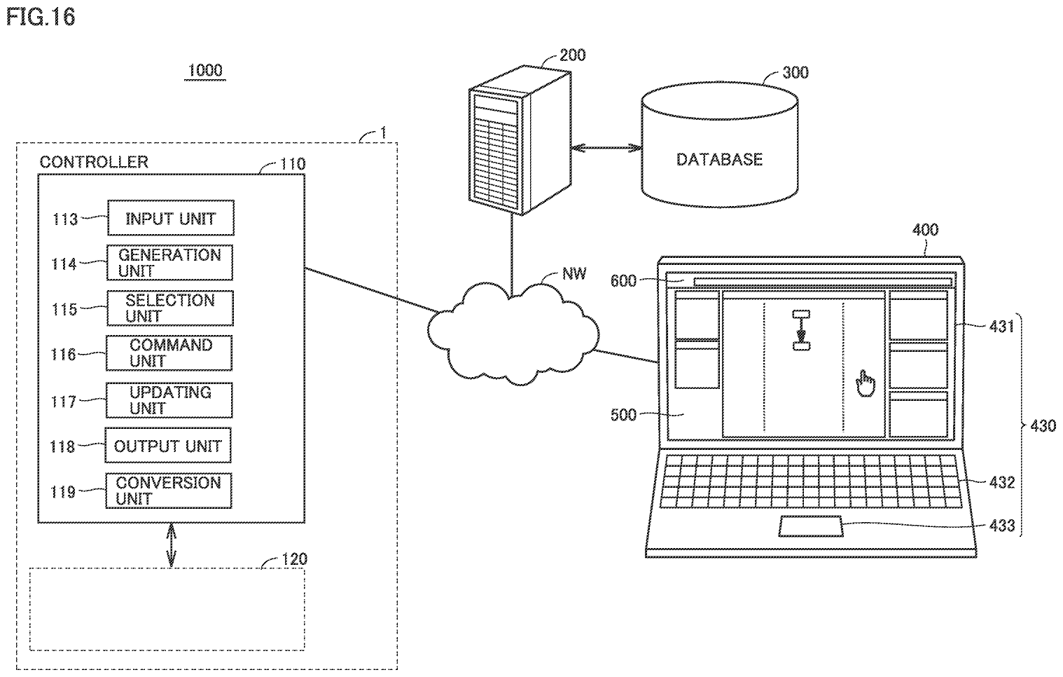

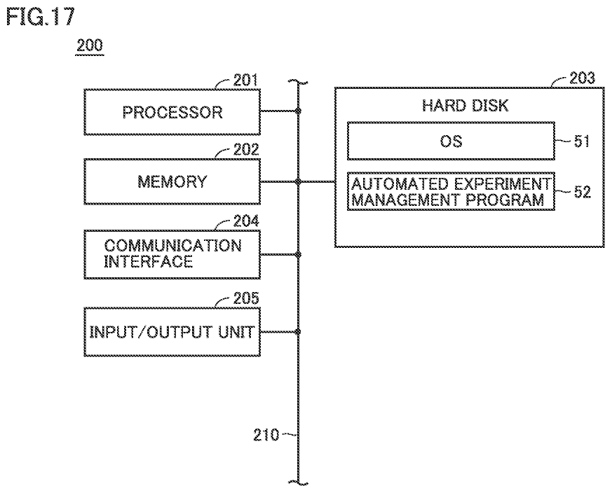

FIG. 16 is a block diagram showing a configuration of automated experiment management system 1000 for illustrating a configuration relevant to a function of controller 110. The processing of controller 110 described based on the flowchart will now be described as a function of controller 110. As shown in FIG. 16, controller 110 includes an input unit 113, a generation unit 114, a selection unit 115, a command unit 116, an updating unit 117, an output unit 118, and a conversion unit 119. These components are implemented by processor 111 and memory 112 of controller 110 shown in FIG. 1.

Input unit 113 receives an input of an experimental protocol designed in a directed graph including a plurality of nodes corresponding to a process of an experiment. Generation unit 114 generates an adjacency matrix list or the like. Based on the adjacency matrix list or the like, selection unit 115 selects from the plurality of nodes a node at which processing is started. Command unit 116 instructs a variety of types of experimental devices to execute the processing of the node selected by selection unit 115. Updating unit 117 updates the adjacency matrix list or the like when any one processing of the plurality of nodes is completed. Output unit 118 outputs a signal for displaying the adjacency matrix list or the like. When the experimental protocol input to input unit 113 is designed in a first directed graph including a node corresponding to a container containing a sample, conversion unit 119 converts the experimental protocol input to input unit 113 into a second directed graph including an operation of a device moving the container.

FIG. 17 is a block diagram illustrating a hardware configuration of server device 200. As illustrated in FIG. 17, server device 200 includes a processor 201, a memory 202 and a hard disk 203 as a storage, a communication interface 204 as a communication unit, and an input and output unit 205. These are communicably interconnected through a bus 210.

Hard disk 203 is a non-volatile storage device. For example, hard disk 203 stores a program 51 of an operating system (OS) and an automated experiment management program 52. For example, settings and outputs of various applications are stored in hard disk 203. Memory 202 is a volatile storage device and incudes a dynamic random access memory (DRAM) for example.

Processor 201 includes a central processing unit (CPU). Processor 201 reads a program stored in hard disk 203 into memory 202 and executes the program to implement various functions of server device 200. For example, processor 201 executing automated experiment management program 52 provides experimental protocol designing application 500 to terminal device 400. Processor 201 is connected to network NW through communication interface 204.

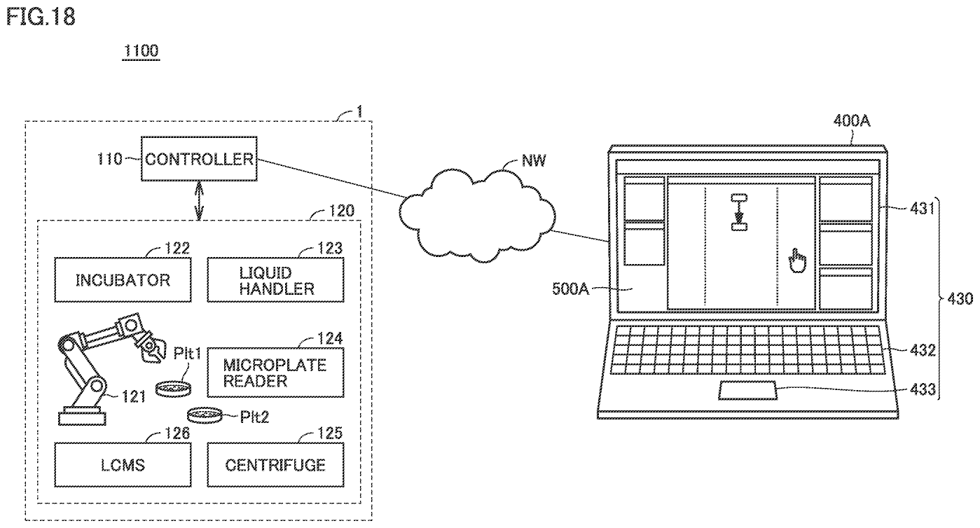

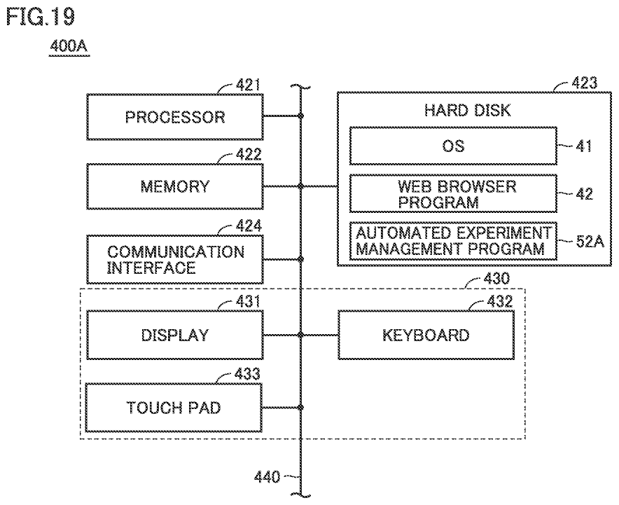

FIG. 18 is a block diagram showing a configuration of automated experiment management system 1100 according to a first exemplary variation of the embodiment. The configuration of automated experiment management system 1100 is a configuration in which server device 200 and database 300 are excluded from automated experiment management system 1000 in FIG. 1 and terminal device 400 is replaced with a terminal device 400A. The remainder is the same, and will not be described repeatedly. An experimental protocol designing application 500A is displayed on display 431 of terminal device 400A.

FIG. 19 is a block diagram illustrating a hardware configuration of terminal device 400A according to the first exemplary variation. The configuration of terminal device 400A is a configuration in which an automated experiment management program 52A is added to hard disk 423 in FIG. 2. The remainder is the same, and will not be described repeatedly. Automated execution of an experimental protocol by experimental protocol designing application 500A and an automated experimental system is implemented when automated experiment management program 52A is executed by processor 421.

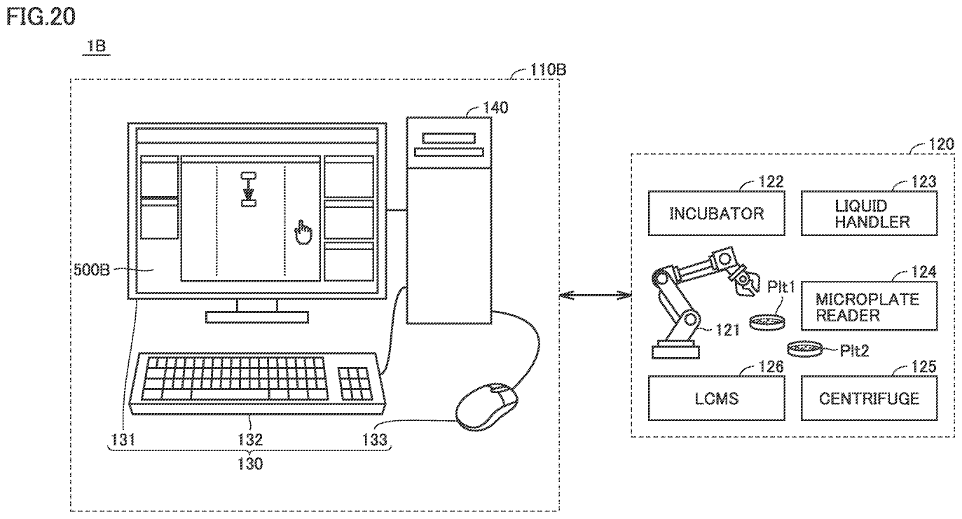

An experimental protocol may be designed in a controller of an automated experimental system. FIG. 20 is a block diagram showing a configuration of an automated experimental system 1B according to a second exemplary variation. The configuration of automated experimental system 1B is a configuration in which controller 110 is replaced with a controller 110B in automated experimental system 1 of FIG. 1. The remainder is the same, and will not be described repeatedly.

As illustrated in FIG. 20, controller 110B includes an input and output unit 130 and a computer 140 (a processing unit). Input and output unit 130 includes a display 131 (a display unit), a keyboard 132 (an input unit), and a mouse 133 (an input unit). Display 131, keyboard 132, and mouse 133 are connected to computer 140. A GUI of an experimental protocol designing application 500B is displayed on display 131. Keyboard 132 and mouse 133 receive a GUI operation input by a user to experimental protocol designing application 500B. That is, the user performs a desired GUI operation to experimental protocol designing application 500B by operating keyboard 132 or mouse 133 while referring to an indication on display 131.

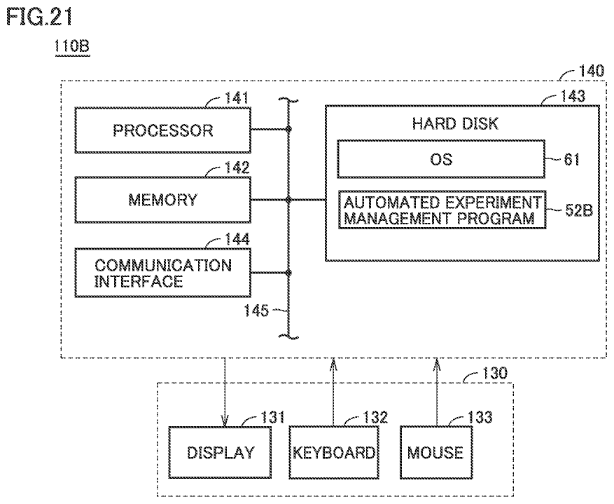

FIG. 21 is a block diagram illustrating a hardware configuration of controller 110B. As illustrated in FIG. 21, computer 140 includes a processor 141, a memory 142 and a hard disk 143 as a storage, and a communication interface 144. These are communicably interconnected through a bus 145.

Hard disk 143 is a non-volatile storage device. For example, a program 61 of an operating system (OS) and an automated experiment management program 52B are stored in hard disk 143. In addition to the data in FIG. 21, for example, settings and outputs of various applications are stored in hard disk 143. Memory 142 is a volatile storage device and incudes a dynamic random access memory (DRAM) for example.

Processor 141 includes a central processing unit (CPU). Processor 141 reads a program stored in hard disk 143 into memory 142 and executes the program. Automated execution of an experimental protocol by experimental protocol designing application 500B and the plurality of experimental devices 120 is implemented when automated experiment management program 52B is executed by processor 141. Processor 141 is connected to a network through communication interface 144.

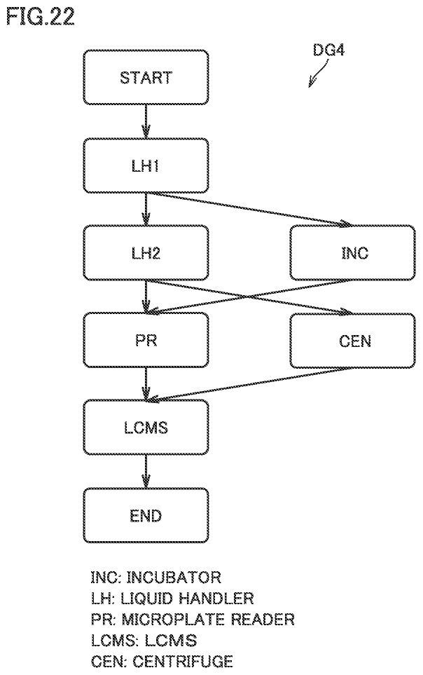

FIG. 22 is a diagram presenting a directed graph DG4. In the present embodiment, terminal device 400 can be used to create a directed graph in a variety of types of formats. In directed graph DG4, a node is specified using a name of a device.

A node LH1 indicates first processing executed by liquid handler 123. Liquid handler 123 distributes a sample, for example. A node LH2 indicates second processing by liquid handler 123. INC represents processing by incubator 122. Incubator 122 for example incubates cells. PR represents processing by microplate reader 124. Microplate reader 124 for example measures an optical property of a sample in a microplate. CEN represents processing by centrifuge 125. LCMS represents processing by liquid chromatograph mass spectrometer 126.

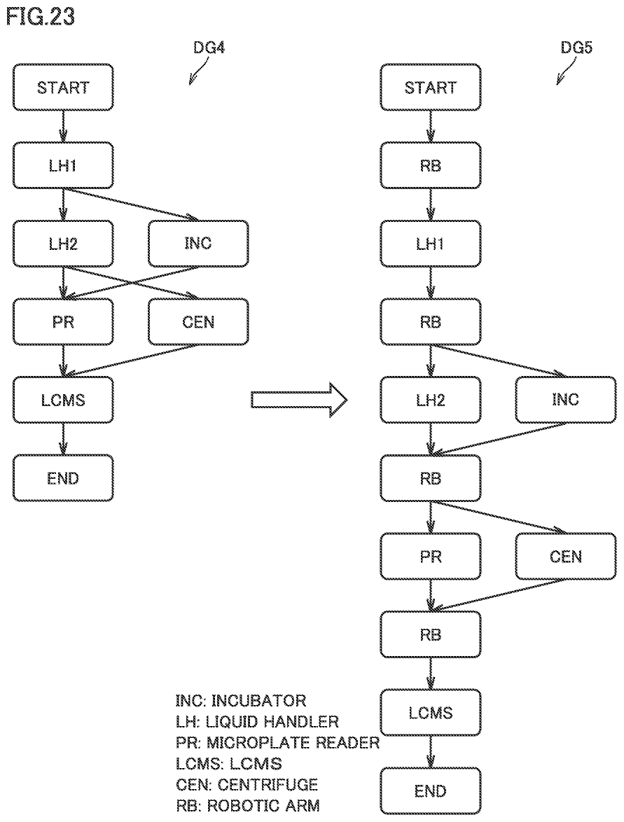

In directed graph DG4, a node for robotic arm 121 is omitted. FIG. 23 is a diagram presenting directed graph DG4 and a directed graph DG5 obtained by adding nodes for robotic arm 121 to directed graph DG4. Controller 110 may be configured to be capable of converting directed graph DG4 into directed graph DG5 with additional nodes for robotic arm 121.

The method and system according to the present embodiment and the first exemplary variation, and the device according to the second exemplary variation of the embodiment, as described above, can provide a method for designing an experimental protocol capable of accommodating a higher level of processing.

According to the present embodiment, an experiment is automatically conducted by controller 110 based on an experimental protocol in the form of a directed graph created by a user. Therefore, according to the present embodiment, the experimental protocol of the graph structure can be executed as it is in automated experimental system 1 with a light-weight implementation.

According to the present embodiment, a device relevant to an experiment is controlled exactly according to an experimental protocol of a graph structure visualized. Therefore, a user can easily create a complicated experimental protocol including parallel processing without considering a period of time required for an operation of a device operating in parallel, a timing of completing the operation, a timing of starting a subsequent operation, etc. Further, as an experiment is conducted based on an experimental protocol including parallel processing, the experiment can be conducted further efficiently.

According to the present embodiment, by using a protocol of a graph structure in which an operation of a device is set as one node, a user can create an easy-to-understand protocol corresponding to an operation of a device grasped by the user. For example, the user can also represent instructions for LCMS autoloader, batch file load, and start batch operations by a single LCMS node.

According to the present embodiment, a user can create an experimental protocol while omitting an operation of robotic arm 121 to transport a sample. In that case, in place of a node of the operation of robotic arm 121, the user can use a node corresponding to a plate with the sample accommodated therein, a node corresponding to a destination to which the plate is moved, and a node corresponding to a source from which the plate is moved. By connecting the nodes by edges so as to correspond to a flow of processing of the experimental protocol, the user can more intuitively create the experimental protocol (see FIG. 6).

According to the present embodiment, by using an adjacency matrix list indicating dependency of nodes, an experiment can be conducted based on a directed graph including parallel processing.

Hereinafter, further exemplary variations and features relevant to the present embodiment will be referred to. The number of types of statuses that can be set in the event handler may be reduced. For example, of “To do,” “Run” and “Done,” “Run” may not be used in updating the event handler. Even when “Run” is not used, controller 110 can determine by “To do” and “Done” whether the processing of a target node needs to be executed or the processing of the target node has already been executed.

The number of types of component values that can be set in the adjacency matrix list may be reduced. For example, of “wait,” “ready” and “passed,” “ready” may not be used in updating the adjacency matrix list. Even when “ready” is not used, controller 110 can determine by “wait” and “passed” whether the processing of a target node is executable.

A type of status that can be set in the event handler may be changed or added. For example, when an error occurs in processing being executed, “Error” may be set in the event handler as a status of a node corresponding to that processing. When the status is set in the event handler, controller 110 may send a restart instruction to a device involved in the processing of the corresponding node.

The adjacency matrix list may have the function of the event handler. For example, the adjacency matrix list may be provided with component values indicating: node waiting for execution; currently executed; and execution completed.

Controller 110 may externally output at least one of the event handler and the adjacency matrix list over a communication network such as the Internet. By causing a display device to display data output from controller 110, a user can remotely grasp how an automated experiment proceeds.

A node included in a directed graph is caused to hold information such as a device to be operated, processing of the device to be operated, and a condition for operation. When an experimental protocol is caused to include a first instruction causing a device to operate when a first condition is established and a second instruction causing a device to operate when a second condition is established, it is desirable that the first instruction and the second instruction be created as different nodes even if the device that operates based on the first instruction and the device that operates based on the second instruction are the same device.

According to an experimental protocol, a sample is produced, prepared and analyzed while being moved between a variety of types of devices by robotic arm 121. According to the present embodiment, when such an experimental protocol is created in a directed graph, the sample can be represented as a node, and a relationship between the devices between which the sample is moved can be represented by an edge. In this case, a user can create the directed graph while omitting a node for operation of robotic arm 121. However, some users may be interested in creating a directed graph representing an operation of robotic arm 121 by a node. Accordingly, terminal device 400 may provide a system environment allowing a user to create such a directed graph.

In a directed graph, a first node and a second node can be interconnected by an edge and the first node and a third node can be interconnected by an edge to represent an instruction to process the second node and the third node in parallel. In that case, a device operating to correspond to the second node and a device operating to correspond to the third node need to be set as different devices. Therefore, when a device designated by a user for the second node and a device designated by the user for the third node are a single device, it is desirable to configure terminal device 400 so as not to accept the user's designation.

However, when there are a plurality of devices of the same type, terminal device 400 may accept the user's such designation. Furthermore, when a sample designated by the user for the second node and a sample designated by the user for the third node are a single sample, it is desirable to configure terminal device 400 so as not to accept the user's designation. As a matter of course, when an order of processing is clearly determined for the processing of the second node and that of the third node, terminal device 400 may accept designation thereof.

When a plurality of experimental devices receive a method of an experimental protocol, statuses such as Ready/Busy, Available/Locked and the like, and a method queue may be managed for each experimental device uniquely.

In order to provide a graph structure of an experimental protocol that is easy to understand for a user, a set of a plurality of instructions including information of a plurality of operating conditions for a device and information of operating conditions for a plurality of devices may be configured as a single node.

There is also an experimental protocol according to which a sample is produced, prepared and analyzed while being moved between a variety of types of devices by robotic arm 121. For such an experimental protocol, a node for an operation of robotic arm 121 alone may be omitted, and an instruction for an operation of a device and an instruction for an operation by robotic arm 121 to load and unload a sample may be provided as a set and represented by a single node. In that case, the plurality of instructions in the single node are executed sequentially. When controller 110 receives from the device a completion signal corresponding to the last instruction, the controller determines that the processing of the node has been completed.

When there are a number of robotic arms 121 corresponding to a number of nodes processed in parallel, an experimental protocol may be designed such that each robotic arm 121 proceeds with processing in parallel. This allows an experimental protocol to be created to allow each robotic arm 121 to transport a sample at the same time for example.

When the number of robotic arms 121 is smaller than the number of parallel nodes, an operation of robotic arm 121 may be represented by a node. When the number of the robotic arms 121 is smaller than the number of the parallel nodes, instead of a node corresponding to an operation of robotic arm 121, a node of robotic arm 121 may be used as a node for a device.

Directed graph DG4 shown in FIG. 23 omits a node for robotic arm 121. When there is only one robotic arm 121 in the system, an operation node for robotic arm 121 may be inserted immediately before a node of each device other than robotic arm 121. In that case, an operation of loading or unloading a sample into or out of each device may be sequentially included in the operation node for robotic arm 121.

When a plurality of nodes have their respective pieces of processing executed in parallel, a node for an operation of robotic arm 121 is inserted immediately before or immediately after a plurality of nodes caused to operate in parallel. For example, in directed graph DG5 shown in FIG. 23, a node RB is inserted immediately before node LH2 and node INC caused to operate in parallel. Further, terminal device 400 may include a constraint under which parallel processing can only be designed for a number corresponding to that of robotic arms 121.

### ASPECTS

It will be understood by those skilled in the art that the exemplary embodiment described above is specific examples of the following aspects:

(Clause 1) According to one aspect, a controller controls an experimental device based on an experimental protocol. The controller comprises: an input unit that receives an input of an experimental protocol designed in the form of a directed graph, the graph including a plurality of nodes corresponding to an experiment process; a generation unit that, when the plurality of nodes include a first node and a second node, generates a dependency list including first dependency information, the second node getting executable in response to completion of processing of the first node, the first dependency information indicating that start of processing of the second node depends on the completion of the processing of the first node; a selection unit that selects, based on the dependency list, a node from the plurality of nodes; a command unit that instructs an experimental device to execute the processing of the node selected by the selection unit; and an updating unit that updates the dependency list in response to completion of any processing for one of the plurality of nodes, the selection unit selecting the second node in response to completion of the processing of the first node is completed.

The controller of clause 1 allows an experiment based on an experimental protocol created in a directed graph to be conducted efficiently.

(Clause 2) The controller of clause 1, wherein the updating unit updates the first dependency information from first information to second information when the processing of the first node is completed, and the selection unit selects the second node when the first dependency information is updated from the first information to the second information.

The controller of clause 2 allows an experiment based on an experimental protocol created in a directed graph to be conducted efficiently.

(Clause 3) The controller of clause 2, wherein the generation unit further generates a status list for determining a status of each of the plurality of nodes, and when the processing of the first node is completed the updating unit updates a status of the first node in the status list from being currently executed to having been completed, and when the processing of the second node is started the updating unit updates a status of the second node in the status list from waiting for execution to being currently executed.

The controller of clause 3 allows a process to proceed while determining a status of each of a plurality of nodes based on the status list.

(Clause 4) The controller of clause 3, wherein the plurality of nodes include a third node executable upon completion of the processing of the first node, the dependency list includes second dependency information indicating that start of processing of the third node depends on the completion of the processing of the first node, the updating unit updates the first dependency information and the second dependency information from the first information to the second information when the processing of the first node is completed, and the selection unit selects the second node and the third node when the first dependency information and the second dependency information are updated from the first information to the second information.

The controller of clause 4 allows the processing of the second node and the processing of the third node to be executed in parallel.

(Clause 5) The controller of clause 4, wherein the plurality of nodes include a fourth node at which processing can be started after the processing of the second node and the processing of the third node are completed, the dependency list includes third dependency information indicating that start of processing of the fourth node depends on the completion of the processing of the second node, and fourth dependency information indicating that the start of the processing of the fourth node depends on the completion of the processing of the third node, the updating unit updates the third dependency information from the first information to the second information when the processing of the second node is completed, and the updating unit updates the fourth dependency information from the first information to the second information when the processing of the third node is completed, and the selection unit selects the fourth node when the third dependency information and the fourth dependency information are updated from the first information to the second information.

The controller of clause 5 allows the processing of the fourth node to be executed when the processing of the second node and that of the third node executed in parallel are completed.

(Clause 6) The controller according to any one of clauses 1 to 5, further comprising an output unit that outputs a signal for displaying the dependency list.

The controller of clause 6 allows a user to grasp how an experimental protocol proceeds by checking the displayed dependency list.

(Clause 7) The controller of any one of clauses 1 to 6, further comprising a conversion unit that, when the experimental protocol input to the input unit is designed in a first directed graph including a node corresponding to a container containing a sample, converts the experimental protocol input to the input unit into a second directed graph including an operation of a device moving the container, wherein the generation unit generates the dependency list based on the second directed graph.

The controller of clause 7 allows an experiment to be conducted based on the first directed graph intuitively created by the user using a node corresponding to a container containing a sample. The user can furthermore easily create an experimental protocol.

(Clause 8) According to one aspect, a method is a method for controlling an experimental device based on an experimental protocol. The method comprises the steps of: receiving an input of an experimental protocol designed in the form of a directed graph, the graph including a plurality of nodes corresponding to an experiment process; when the plurality of nodes include a first node and a second node, generating a dependency list including first dependency information, the second node getting executable in response to completion of processing of the first node, the first dependency information indicating that start of processing of the second node depends on the completion of the processing of the first node; selecting, based on the dependency list, a node from the plurality of nodes for starting processing; instructing an experimental device to execute the processing of the selected node; and updating the dependency list in response to completion of any processing for one of the plurality of nodes, the selecting a node at which processing is started including selecting the second node in response to completion of the processing for the first node is completed.

The method of clause 8 allows an experiment based on an experimental protocol created in a directed graph to be conducted efficiently.

It is to be noted that, regarding the above-described embodiment and exemplary variations, the configurations described in the embodiment, including combinations which are not mentioned in the specification, are intended to be combined, as appropriate, within a range in which no disadvantage or contradiction occurs.

It should be understood that the presently disclosed embodiment is illustrative and non-restrictive in any respect. The scope of the present invention is defined by the terms of the claims, rather than the above description, and is intended to include any modifications within the meaning and scope equivalent to the terms of the claims.

### REFERENCE SIGNS LIST

1, 1B automated experimental system, 110, 110B controller, 111 processor, 112 memory, 113 input unit, 114 generation unit, 115 selection unit, 116 command unit, 117 updating unit, 118 output unit, 119 conversion unit, 120 experimental device, 121 robotic arm, 122 incubator, 123 liquid handler, 124 microplate reader, 125 centrifuge, 130, 205, 430 input/output unit, 131, 431 display, 132, 432 keyboard, 133 mouse, 140 computer, 141, 201, 421 processor, 142, 202, 422 memory, 143, 203, 423 hard disk, 144, 204, 424 communication interface, 145, 210, 440 bus, 200 server device, 300 database, 400, 400a terminal device, 433 touch pad, 500, 500A, 500B experimental protocol designing application, 510 queue list window, 520 protocol list window, 530 protocol design window, 531 container region, 532 processing region, 533 data region, 540 automated experimental system window, 550 sample container window, 560 tool window, 570 information window, 600 web browser, 1000, 1100 automated experiment management system, Cr selection cursor, NW network, Plt1, Plt2 plates, p1 experimental protocol.

1. A controller that controls an experimental device based on an experimental protocol, comprising:
an input unit that receives an input of an experimental protocol designed in the form of a directed graph, the graph including a plurality of nodes corresponding to an experiment process;
a generation unit that, when the plurality of nodes include a first node and a second node, generates a dependency list including first dependency information, the second node getting executable in response to completion of processing of the first node, the first dependency information indicating that start of processing of the second node depends on the completion of the processing of the first node;
a selection unit that selects, based on the dependency list, a node from the plurality of nodes for starting processing;
a command unit that instructs an experimental device to execute the processing of the node selected by the selection unit; and
an updating unit that updates the dependency list in response to completion of any processing for one of the plurality of nodes,
the selection unit selecting the second node in response to completion of the processing for the first node is completed.

2. The controller according to claim 1, wherein
the updating unit updates the first dependency information from first information to second information when the processing of the first node is completed, and
the selection unit selects the second node when the first dependency information is updated from the first information to the second information.

3. The controller according to claim 2, wherein
the generation unit further generates a status list for determining a status of each of the plurality of nodes, and
when the processing of the first node is completed the updating unit updates a status of the first node in the status list from being currently executed to having been completed, and when the processing of the second node is started the updating unit updates a status of the second node in the status list from waiting for execution to being currently executed.

4. The controller according to claim 3, wherein
the plurality of nodes include a third node executable upon completion of the processing of the first node,
the dependency list includes second dependency information indicating that start of processing of the third node depends on the completion of the processing of the first node,
the updating unit updates the first dependency information and the second dependency information from the first information to the second information when the processing of the first node is completed, and
the selection unit selects the second node and the third node when the first dependency information and the second dependency information are updated from the first information to the second information.

5. The controller according to claim 4, wherein
the plurality of nodes include a fourth node at which processing can be started after the processing of the second node and the processing of the third node are completed,
the dependency list includes third dependency information indicating that start of processing of the fourth node depends on the completion of the processing of the second node, and fourth dependency information indicating that the start of the processing of the fourth node depends on the completion of the processing of the third node,
the updating unit updates the third dependency information from the first information to the second information when the processing of the second node is completed, and the updating unit updates the fourth dependency information from the first information to the second information when the processing of the third node is completed, and
the selection unit selects the fourth node when the third dependency information and the fourth dependency information are updated from the first information to the second information.

6. The controller according to claim 1, further comprising an output unit that outputs a signal for displaying the dependency list.

7. The controller according to claim 1, further comprising a conversion unit that, when the experimental protocol input to the input unit is designed in a first directed graph including a node corresponding to a container containing a sample, converts the experimental protocol input to the input unit into a second directed graph including an operation of a device moving the container, wherein
the generation unit generates the dependency list based on the second directed graph.

8. A method for controlling an experimental device based on an experimental protocol, comprising:
receiving an input of an experimental protocol designed in the form of a directed graph, the graph including a plurality of nodes corresponding to an experiment process;
when the plurality of nodes include a first node and a second node, generating a dependency list including first dependency information, the second node getting executable in response to completion of processing of the first node, the first dependency information indicating that start of processing of the second node depends on the completion of the processing of the first node;
selecting, based on the dependency list, a node from the plurality of nodes for starting processing;
instructing an experimental device to execute the processing of the selected node; and
updating the dependency list in response to completion of any processing for one of the plurality of nodes,
the selecting a node at which processing is started including selecting the second node in response to completion of the processing for the first node is completed.
